(19) United States
(12) Patent Application Publication
(10) Pub. No.: US 2011/0236670 A1
(43) Pub. Date: Sep. 29, 2011

(54) REINFORCED COMPOSITE PART COMPOSED OF AN ASSEMBLY OF AT LEAST TWO DIFFERENT COMPOSITE MEMBERS

(75) Inventors: Steffen Kunze, Vagen (DE); Christian Wellhausen, Ottobrunn (DE); Tim Roser, Donauworth (DE)

(73) Assignee: EUROCOPTER DEUTSCHLAND GMBH, Donauworth (DE)

(21) Appl. No.: 13/053,703

(22) Filed: Mar. 22, 2011

(30) Foreign Application Priority Data
Mar. 25, 2010 (EP) 10 400019.5

(51) Int. Cl. B32B 3/26; B32B 5/02; B32B 5/16; B32B 7/12; B82Y 30/00

(52) U.S. Cl. 428/313.3; 428/221; 428/408; 428/335; 977/755; 977/742; 977/962

(57) ABSTRACT

The present invention concerns an intermediate reinforced composite part composed of an assembly of at least two composite members (1,2,4,5) each comprising reinforcing fibres or fabrics and an impregnation matrix, said assembly comprising a bonding agent (3) ensuring a mechanical bond between said members, characterised in that the bonding agent (3) comprises at least one carbon nanotube (“Bucky Paper”) sheet.

### CROSS REFERENCE TO RELATED APPLICATIONS

The present application claims the benefit of European patent application EP 10 400019.5 filed on Mar. 25, 2010, the disclosure of which is incorporated herein by reference.

### BACKGROUND OF THE INVENTION

(1) Field of the Invention

The present invention generally concerns the manufacture of parts made of metallic or organic materials comprising, for example, reinforcing fibres and a resin-type impregnation matrix. These parts or members thereof are obtained, for example, by moulding a fibre-reinforced composite material.

More specifically, the present invention concerns the manufacture of composite parts composed of several different members assembled in a manner ensuring good and reliable adhesion of said members. These members may, for example, form a hybrid assembly with a pre-impregnated member (<<prepreg>>) and a member requiring the infusion of an impregnation matrix prior to simultaneous or individual curing of the members. The invention also concerns other types of assemblies.

Hereinafter, specific reference will be made to intermediate reinforced composite parts. Such parts are referred to as intermediate because, after the assembly of their constituent members, a bonding agent or at least one of said members must still undergo an impregnation and/or curing process.

(2) Description of Related Art

For example, document DE 10 2005 008 252 describes a process to assemble two members composed of fibre-reinforced composite materials with different matrix structures. The two matrices are fluidified in a time-shifted manner, with the fluidification of the first matrix ensuring penetration into the surface layer of the second matrix, followed by the fluidification of said second matrix and the simultaneous curing of both matrices. A mechanical bond is then obtained through adhesion with random-shaped constituent materials of the cured and interpenetrated matrices in a surface layer. However, with such an assembly, it is difficult to obtain a homogeneous bond over a large surface.

In addition, document EP 1 916 091 describes a complex two-member assembly process wherein a thermoplastic sheet is used at the interface between two fibre-reinforced composite material members. The faces of the thermoplastic sheet have different properties so as to optimise the bond with the different matrix structures of said members. The use of a thermoplastic sheet poses the disadvantage of weakening the stability and mechanical bonding strength of the cured assembly. The performance characteristics of such an assembly are therefore significantly reduced. The thermoplastic sheet constitutes a distinct phase in a resin-type matrix environment. This results in limited performance, particularly in terms of the mechanical bonding properties and thermal stability of the assembly.

The document US 2009/0117363 discloses the use of a carbon nanotube layer in a composite ply structure, which comprises an assembly of composite members each comprising reinforcing fibres impregnated with a matrix. The assembly comprises a bonding agent ensuring a mechanical bond between the plies. The bonding agent comprises a carbon nanotube film.

### SUMMARY OF THE INVENTION

The present invention therefore aims to propose a new assembly of different composite members without the above-mentioned disadvantages and with improved bonding performance and thermal stability.

Another aim of the present invention is to propose an assembly whose manufacture is technically simple, on the one hand, and not costly in terms of time and money, on the other hand.

Another aim of the present invention is to provide a new assembly applicable to identical, similar or different composite members and/or suited for a broad range of manufacturing processes.

The aims of the present invention are achieved by means of an intermediate reinforced composite part composed of an assembly of at least two composite members each comprising reinforcing fibres or fabrics which are or have to be impregnated by impregnation matrix, said assembly comprising a bonding agent ensuring a mechanical bond between said members, said bonding agent comprising at least one carbon nanotube sheet (bucky paper), characterised in that the composite assembly comprises precured members, the carbon nanotube sheet being associated with an adhesive layer on each face intended to come into contact with a precured member.

According to an exemplary embodiment of the present invention, the carbon nanotube sheet has a thickness of between 5 micrometers and 50 micrometers.

According to an exemplary embodiment of the present invention, the density of the carbon nanotubes is comprised between 1 and 3 g/cm³ thus providing the bonding agent with a determined porosity.

According to an exemplary embodiment of the present invention, the composite assembly comprises a pre-impregnated member (prepreg) and a dry member that is subsequently infused with an impregnation matrix once the assembly has been achieved.

The term dry member is to be understood as referring to any member or structure comprising reinforcing fibres or fabrics not yet impregnated with a resin-type matrix.

According to an exemplary embodiment of the present invention, the composite assembly comprises a pre-impregnated member (prepreg) and a precured member.

According to an exemplary embodiment of the present invention, the composite assembly comprises a precured member and a dry member that is subsequently infused with an impregnation matrix once the assembly has been achieved.

According to an exemplary embodiment of the present invention, the composite assembly comprises precured members, the carbon nanotube sheet being associated with an adhesive layer on each face intended to come into contact with a precured member.

According to an exemplary embodiment of the present invention, the composite assembly comprises pre-impregnated members (prepregs).

According to an exemplary embodiment of the present invention, the composite assembly comprises dry members that are subsequently impregnated/infused with an impregnation matrix once the assembly has been achieved.

The aims of the present invention are also achieved by means of a reinforced and cured composite structure comprising at least one intermediate reinforced composite part such as described above.

One advantage of the part according to the present invention is the absence of detrimental barrier effects generated by thermoplastic sheets in known assemblies. The properties and functions of the impregnation resins are not altered by the presence of a distinct phase between the constituent members of the assembly.

Another advantage of the part according to the present invention is the possibility of avoiding unwanted mixtures or interpenetrations of matrices with different structures, particularly when forming a hybrid assembly comprising a pre-impregnated member and a dry member to be subsequently infused.

Another advantage of the part according to the present invention is the possibility of choosing a carbon nanotube sheet with a determined porosity, so as to control the porosity at the interface of the assembly.

Another advantage of the part according to the present invention is that the carbon nanotube sheet is chemically stable.

Another advantage of the part according to the present invention is that the carbon nanotube sheet comprises pure surfaces with good adhesive properties. These properties are present on each face of said sheet, thereby favouring bonding with resins or adhesives.

Another advantage of the part according to the present invention is that it becomes possible to change the electrical properties of the composite part (e.g. for electrical bonding and/or electro-magnetic compatibility.

### BRIEF DESCRIPTION OF THE DRAWINGS

The characteristics and advantages of the present invention will become more apparent from the following description of an illustrative exemplary embodiment, given with reference to the attached figures, where:

FIG. 1 is a schematic cross-sectional view of an exemplary embodiment of an intermediate reinforced composite part according to the present invention, comprising a pre-impregnated member and a dry member,

FIG. 2 is a schematic cross-sectional view of another exemplary embodiment of an intermediate reinforced composite part according to the present invention, comprising a pre-impregnated member and a precured member,

FIG. 3 is a schematic cross-sectional view of another exemplary embodiment of an intermediate reinforced composite part according to the present invention, comprising a dry member and a precured member,

FIG. 4 is a schematic cross-sectional view of another exemplary embodiment of an intermediate reinforced composite part according to the present invention, comprising two precured members,

FIG. 5 is a schematic cross-sectional view of another exemplary embodiment of an intermediate reinforced composite part according to the present invention, comprising two pre-impregnated members,

FIG. 6 is a schematic cross-sectional view of another exemplary embodiment of an intermediate reinforced composite part according to the present invention, comprising two dry members.

### DETAILED DESCRIPTION OF THE PREFERRED EMBODIMENTS

Structurally and functionally identical components appearing in different figures are assigned the same numerical or alphanumerical reference.

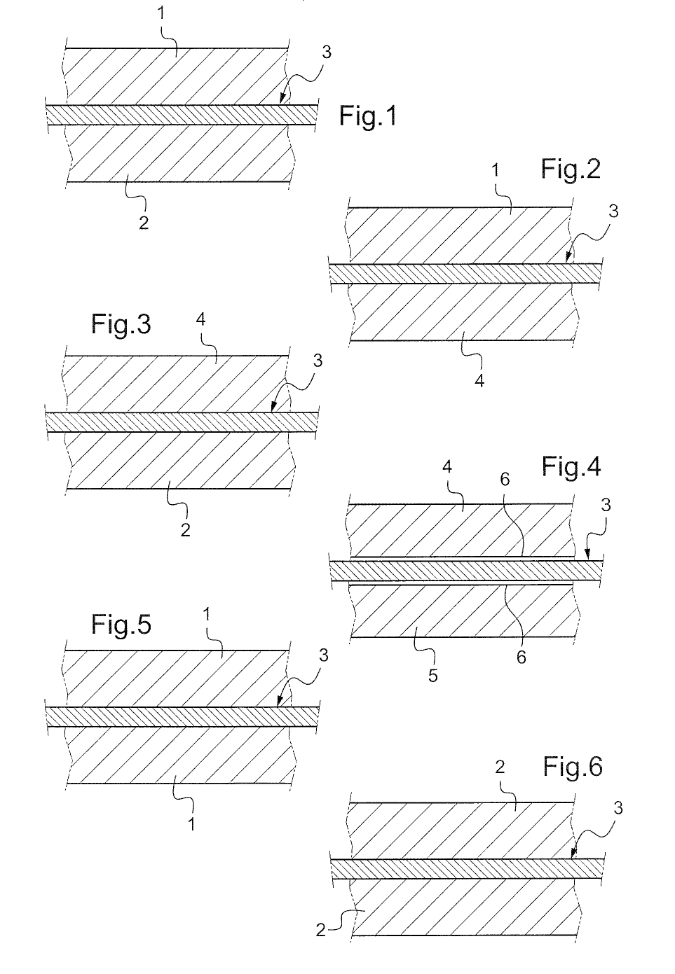

FIGS. 1 to 6 show exemplary embodiments of an intermediate reinforced composite part according to the present invention composed of an assembly of at least two composite members 1,2,4,5 each comprising reinforcing fibres or fabrics and an impregnation matrix. The assemblies shown also comprise a bonding agent 3 ensuring a mechanical bond between said members.

The bonding agent 3 comprises at least one carbon nanotube sheet.

Preferably, the carbon nanotube sheet has a thickness of between 5 micrometers and 50 micrometers.

The density of the carbon nanotubes constituting the carbon nanotube sheet is advantageously comprised between 1 and 3 g/cm³ thus providing the bonding agent with a determined porosity.

The carbon nanotube sheet, also referred to as <<free standing nanotube paper>> or <<bucky paper>>, is obtained, for example, through filtration of a solution containing purified carbon nanotubes. This filtration process is known as such.

The term <<carbon nanotube sheet>> is also to be understood as referring more generally to another materials or substrates, of the kind of semi-finished sheet of products made from carbon nanotubes.

FIG. 1 shows an exemplary embodiment of an intermediate composite part according to the present invention, comprising a pre-impregnated member (prepreg) 1 and a dry member 2 that is subsequently infused with an impregnation matrix once the assembly has been achieved.

This impregnation operation, known as such, is not described. The same applies to curing operations implemented in known industrial processes.

The structure of the impregnation matrix to be subsequently infused into the dry member 2 may be identical, similar or different from that used to achieve the pre-impregnated member 1.

The intermediate reinforced composite part shown in FIG. 2 differs from that described above in that the dry member 2 is replaced with a precured member 4.

The intermediate reinforced composite part shown in FIG. 3 comprises a precured member 4 and a dry member 2 that is subsequently infused with an impregnation matrix once the assembly has been achieved.

The intermediate reinforced composite part shown in FIG. 4 comprises precured members 4 and 5. The carbon nanotube sheet (“Bucky Paper)” is associated with an adhesive layer 6 on each face intended to come into contact with a precured member 4, 5. The carbon nanotube sheet thereby improves the bonding power of the adhesive layers 6. The bonding agent 3 is therefore composed of the carbon nanotube sheet associated with the adhesive layers 6. Examples of adhesive layers 6 are adhesives called FM73 or FM300.

The intermediate reinforced composite part shown in FIG. 5 comprises pre-impregnated members (prepregs) 1.

The intermediate reinforced composite part shown in FIG. 6 comprises dry members 2 that are subsequently infused with an impregnation matrix once the assembly has been achieved.

In the exemplary embodiments shown in FIGS. 1, 5 and 6, matrices with different, similar or identical structures can be used for the pre-impregnated members 1 or dry members 2 of the assembly. The choice of resin-type matrix depends in particular on the performance characteristics sought for the assembly and on the specific physical or chemical properties possibly sought on both sides of the bonding interface.

The impregnation matrices are for instance HexFlow RTM6, Henkel Epsilon variants, PR500/PR520, Cytec 977.

Based on these criteria, it is then possible to proceed with simultaneous curing of the assembly or individual curing of each constituent member thereof. Individual curing must be considered when the matrix structures require different temperature and/or pressure conditions, or when the assembly is used as a constituent member of another part or structure.

A reinforced and cured composite structure comprising at least one intermediate reinforced composite part such as described above can be advantageously used in particular in aeronautical, automotive and wind energy applications.

Naturally, the present invention can be subjected to numerous variations as to its implementation. Although various embodiments and implementations have been described herein, it will be readily understood that it is not conceivable to exhaustively identify all possible variations. The possibility of replacing one of the means described herein with an equivalent means can, of course, be considered without departing from the scope of the present invention.

What is claimed is:

1. An intermediate reinforced composite part composed of an assembly of at least two composite members each comprising reinforcing fibres or fabrics which are or have to be impregnated by impregnation matrix, said assembly comprising a bonding agent ensuring a mechanical bond between said members, said bonding agent comprising at least one carbon nanotube sheet,
the composite assembly further comprising precured members, the carbon nanotube sheet being associated with an adhesive layer on each face intended to come into contact with a precured member.

2. An intermediate reinforced composite part according to claim 1, wherein the carbon nanotube sheet has a thickness of between 5 micrometers and 50 micrometers.

3. An intermediate reinforced composite part according to claim 1, wherein the density of the carbon nanotubes is between 1 and 3 g/cm³, thus providing the bonding agent with a determined porosity.

4. An intermediate reinforced composite part according to claim 1, wherein the composite assembly comprises a pre-impregnated member (prepreg) and a dry member that is subsequently infused with an impregnation matrix once the assembly has been achieved.

5. An intermediate reinforced composite part according to claim 1, wherein the composite assembly comprises a pre-impregnated member (prepreg) and a precured member.

6. An intermediate reinforced composite part according to claim 1, wherein the composite assembly comprises a precured member and a dry member that is subsequently infused with an impregnation matrix once the assembly has been achieved.

7. An intermediate reinforced composite part according to claim 1, wherein the composite assembly comprises pre-impregnated members (prepregs).

8. An intermediate reinforced composite part according to claim 1, wherein the composite assembly comprises dry members that are subsequently impregnated/infused with an impregnation matrix once the assembly has been achieved.

9. A reinforced and cured composite structure comprising at least one intermediate reinforced composite part according to claim 1.
